(19) United States
(12) Patent Application Publication
(10) Pub. No.: US 2018/0016932 A1
(43) Pub. Date: Jan. 18, 2018

(54) ADJUSTING DEVICE

(71) Applicant: Mahle International GmbH, Stuttgart (DE)

(72) Inventors: Eugen Makarow, Ludwigsburg (DE); Edgar Salfeld, Lichtenwald (DE); Florian Wetzel, Baltmannsweiler (DE)

(21) Appl. No.: 15/647,252

(22) Filed: Jul. 11, 2017

(30) Foreign Application Priority Data
Jul. 12, 2016 (DE) 10 2016 212 668.7

(51) Int. Cl. F01D 17/24; F01D 7/00; F16K 31/04

(52) U.S. Cl. CPC F01D 17/24; F16K 31/04; F01D 7/00; F05D 2220/40

(57) ABSTRACT

An actuating device may include a housing having a first housing part made of plastic and a second housing part, and an electric motor arranged in the second housing part having a drive shaft projecting axially into the first housing part for driving an actuator arranged on an outside of the housing for coupling to the component to be actuated. The actuating device may also include a cooling channel formed in the second housing part and fluidically connected to coolant inlet and outlet connections provided on the outside of the housing, an electronic system arranged in the first housing part, an axial recess formed at least in a region of the electronic system on the first housing part, and an axial heat-conducting elevation provided on the second housing part and extending at least in the region of the electronic system axially into the recess.

### CROSS-REFERENCE TO RELATED APPLICATIONS

This application claims priority to German Patent Application No. DE 10 2016 212 668.7, filed on Jul. 12, 2016, the contents of which are incorporated herein in their entirety.

### TECHNICAL FIELD

The present invention relates to an adjusting device for the mechanical actuation of a component of a machine. The invention in particular relates to an exhaust gas turbocharger which is fitted with such an adjusting device.

### BACKGROUND

In many machines there are components which must be actuated mechanically so that the respective component can fulfil the function assigned to it inside the respective machine. Of preferred interest as a machine here is an exhaust gas turbocharger which for example can have a variable turbine geometry or a waste gate valve as actuatable component. Accordingly, such an exhaust gas turbocharger can be fitted with an adjusting device in order to actuate the variable turbine geometry or the waste gate valve as required. Naturally other machines can also be fitted with such adjusting devices. For example, a pump can represent such a machine which has a valve for adjusting a volume flow as actuatable component. It is also feasible to interpret an exhaust gas recirculation system as a machine which has an exhaust gas recirculation valve for adjusting an exhaust gas recirculation rate as actuatable component. This machine can also be fitted with an adjusting device for actuating the exhaust gas recirculation valve.

Adjusting devices which are suitable for the mechanical actuation of a component of a machine fundamentally comprise a housing and an electric motor arranged in the housing for driving an actuator arranged on the outside of the housing which is provided for coupling to the respective component to be actuated. In the housing further components of the adjusting device can be arranged, such as for example, a transmission device which is drivingly arranged between a drive shaft of the electric motor and the respective actuator.

Also an electronic system can be arranged in the housing, in particular a sensor for detecting a current position or rotational position of the actuator relative to the housing.

The housing of the adjusting device usually has a plurality of, mostly two, housing parts for production technology reasons. Depending on the application, as a result of the areas of use, for example on an exhaust gas turbocharger or an exhaust gas recirculation system, such an adjusting device is exposed to relatively high ambient temperatures. In this respect, it is known that cast aluminium housings which have a low weight and a good thermal conductivity are frequently used. It is known that the lifetime of electrical and electronic components depends strongly on the operating temperature; the higher the operating temperature, the shorter the lifetime. In the case of an adjusting device with an electric motor, another complicating factor is that the electric motor itself generates heat during operation.

Generally known from the prior art are adjusting devices which on the one hand have a metallic housing part and on the other hand a housing part made of plastic. In the configuration of a housing part made of plastic, dissipation of heat is frequently a problem since plastic has a poor thermal conductivity. Housings having cooling channels arranged in an integrated manner through which a fluid can flow are also sufficiently known for the cooling of such an adjusting device.

Known from WO 2014/090946 A2 is an actuator comprising a metal housing consisting of a plurality of housing parts, an electric motor, an actuator, a transmission mechanism which adapts the movement of the electric motor to the actuator and an electronic system for triggering the electric motor, wherein at least one housing part consists of plastic and a heat sink is arranged in the region of the housing part consisting of plastic. The heat sink has thermal connecting surfaces for the electronic system and is connected to a metal housing part.

### SUMMARY

The present invention is concerned with the problem of providing an improved or at least a different embodiment for an adjusting device of the aforesaid type which is characterized by a reduced thermal loading of the electronic system and in particular can be fabricated more cost-effectively in view of the easier manufacturing process.

This problem is solved for an adjusting device according to the invention by the subject matter of the independent claim 1 and for an exhaust gas turbocharger by the subject matter of claim 17. Advantageous embodiments are the subject matter of the dependent claims.

The invention is based on the general idea that in an actuating device, an electronic system located in the first housing part, in particular a sensor system is thermally connected to a cooling channel located in the second housing part in order to cool this accordingly. To this end the actuating device has a two-part housing having a first housing part made of plastic and a second housing part. An electric motor is arranged in the second housing part which projects at least with its drive shaft axially into the first housing part for driving an actuator arranged on the outside of the housing for coupling to the component to be actuated. Furthermore a cooling channel is formed in the second housing part, through which a coolant can flow, which is fluidically connected to a coolant inlet connection provided on the outside of the housing and a coolant outlet connection provided on the outside of the housing. It is essential to the invention that an axial recess is provided at least in the region of the electronic system in the first housing part into which a heat-conducting elevation provided axially on the second housing part extends at least in the region of the electronic system.

In an advantageous embodiment, the elevation is connected to the electronic system directly or indirectly in a heat-conducting manner. Furthermore, the elevation can thus abut directly against the electronic system or indirectly against the electronic system via an electrical insulation and/or heat-conducting layer. Expediently the elevation can have an electrically conducting coating at least on one surface in contact with the electronic system in order to achieve electrical insulation between the electronic system and the fluid flowing through the cooling channel.

In a preferred embodiment, the cooling channel extends in the circumferential direction around the electric motor and is delimited radially between a fluid-tight outer jacket wall of the second housing part outwards and a fluid-tight inner jacket wall of the second housing part inwards. The inner jacket wall thereby encloses a receiving space of the second housing part in the circumferential direction into which the electric motor is inserted. Expediently the cooling channel arranged in the second housing part is axially open on a side facing the first housing part and is axially closed in a fluid-tight manner by placement of the first housing part thereon.

In a further advantageous embodiment a web is provided which extends from the outer jacket wall to the inner jacket wall and in the cooling channel separates a coolant inlet region connected to the coolant inlet connection from an outlet region connected to the coolant outlet connection. By arranging such a web, the coolant is guided in the circumferential direction around the electric motor. The elevation is preferably provided in the region of the web.

In a first embodiment according to the invention, the second housing part is made of metal, in particular of aluminium. In this embodiment, the heat-conducting elevation is formed integrally on the second housing part and projects on a side facing the first housing part. The elevation projects into the recess in the region of the electronic system of the first housing part and thus removes the heat from the electronic system and accordingly has a cooling effect. The cooling effect on the electronic system can thus be increased so that the electronic system remains operational even at high ambient temperatures.

In a second embodiment according to the invention, the second housing part is also made of plastic, in particular as an injection-moulded part. For heat dissipation, the second housing part has a metal heat-conducting element on which the elevation is formed. The heat-conducting element extends from the elevation which projects into the first housing part as far as the cooling channel in the second housing part. Expediently the heating-conducting element is connected with a part of its surface, as far as possible with a large area, in a heat-conducting manner to the electronic system in the first housing part, wherein the heat-conducting element can partially or completely embrace the electronic system. The embodiment described where both housing parts are made of plastic is cost-effective to manufacture as a result of the simple manufacturing process.

Expediently, the heat-conducting element is exposed to the coolant on or in the cooling channel. In this case, the heat-conducting element should be configured in such a manner that it has a contour which has the largest possible area in order to increase the contact surface for heat transfer between the heat-conducting element and the coolant. It is also feasible that the heat-conducting element preferably forms a large-area part of the cooling channel outer wall. Furthermore, the heat-conducting element can preferably have an electrically insulating coating on a surface in contact with the coolant so that an electrical separation between the electronic system and the coolant can be ensured.

In a preferred embodiment the heat-conducting element forms the previously described web for separation of the inlet region of the coolant from the outlet region of the coolant in the cooling channel.

Particularly advantageous is an embodiment in which the heat-conducting element is at least partially encased by the plastic of the second housing part. Alternatively the heat-conducting element can be at least partially injection-moulded with the plastic of the second housing part. A further possibility consists in that the heat-conducting element is laid in or inserted in the second housing part after the injection moulding process.

In an advantageous embodiment, the heat-conducting element is inserted into the second housing part as an independent component in the region of the cooling channel. In this embodiment, in addition an at least partially radial recess can be provided on the second housing part on a side facing the first housing part in the region of the elevation. In this case, the heat-conducting element can have a positioning section in the region of the elevation, which is inserted in the previously described radial recess. The positioning section thus extends axially into the second housing part in the region of the elevation. The heat-conducting element in an inserted state with the exception of the elevation forms a flat surface with the second housing part on a side facing the first housing part. That is, that apart from the elevation, the heat-conducting element is arranged in a recessed manner in an end face of the second housing part facing the first housing part in such a manner that the heat-conducting element ends flush with this end face.

It is feasible for simplified assembly of the two housing halves that the facing sides of the housing parts rest flat on one another except for the elevation. Expediently an axial seal is provided between the two housing parts which on the one hand seals the cooling channel inwards and outwards and on the other hand protects the entire housing from impurities from outside. For positioning a respective seal a suitable groove for this can be formed on the first housing part or on the second housing part. It is also possible to injection mould or foam the seal onto the first or the second housing part. In principle, both individual sealing rings and also a cohesive one-part sealing element can be used.

In a preferred embodiment an exhaust gas turbocharger for a motor vehicle is fitted with such an adjusting device.

Further important features and advantages of the invention are obtained from the subclaims, from the drawings and from the relevant description of the figures with reference to the drawings.

It is understood that the features mentioned previously and to be explained further hereinafter can be used not only in the respectively given combination but also in other combinations or alone without departing from the scope of the present invention.

Preferred exemplary embodiments of the invention are presented in the drawings and are explained in detail in the following description, where the same reference numbers relate to the same or similar or functionally the same components.

### BRIEF DESCRIPTION OF THE DRAWINGS

In the figures, in each case schematically

FIG. 1 shows a sectional view in the region of the elevation on the second housing part of the adjusting device,

FIG. 2 shows an isometric view of the second housing part of the adjusting device, in particular of a metal material,

FIG. 3 shows a sectional view in the region of the heat-conducting element on the second housing part of the adjusting device,

FIG. 4 shows an isometric view of the heat-conducting element,

FIG. 5 shows an isometric view of the second housing part of the adjusting device with inserted heat-conducting element,

FIG. 6 shows the isometric view from FIG. 5 with arranged sealing element.

### DETAILED DESCRIPTION

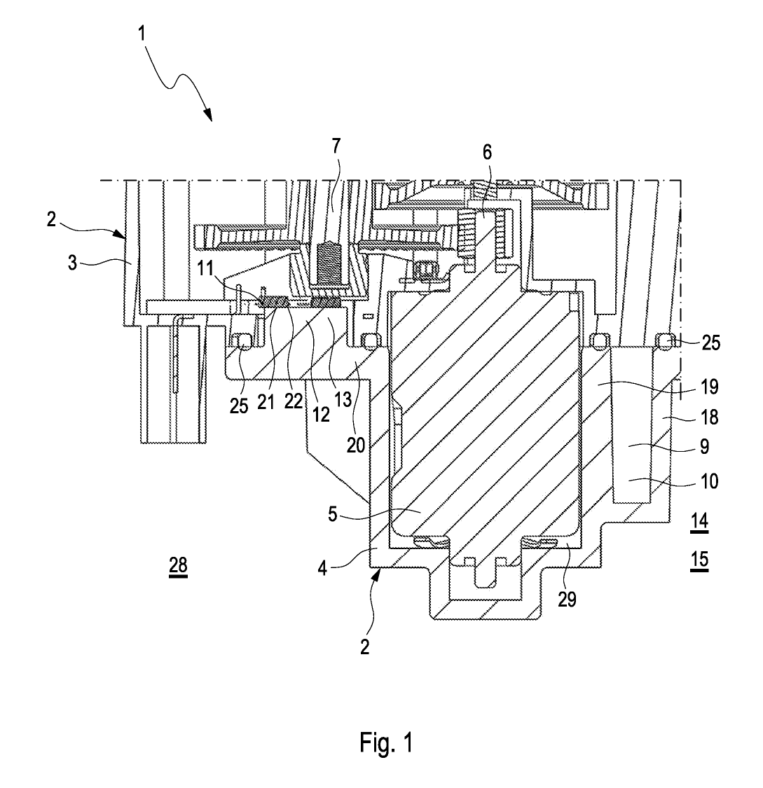

FIG. 1 shows schematically an adjusting device 1 for mechanical actuation of a component of a machine not shown otherwise. The housing 2 of the adjusting device 1 comprises a first housing part 3 and a second housing part 4. An electric motor 5 arranged in the second housing part 4 projects at least with its drive shaft 6 axially into the first housing part 3, wherein this interacts via a transmission device 7 with an actuator arranged on the outside of the housing 2 for coupling with the component to be actuated. Arranged in the second housing part 4 is a cooling channel 9 through which a coolant 10 can flow, which is connected fluidically to a coolant inlet connection 14 arranged on the outside of the housing 2, which cannot be identified in the sectional view, and to a coolant outlet connection 15 also arranged on the outside of the housing 2. An electronic system 11 is arranged in the first housing part 3, which for example can comprise a Hall sensor for detecting the position of the electric motor 5. In the region of this electronic system 11 an axial recess 12 is provided on a side facing the second housing part 4. On the second housing part 4 again in the region of the electronic system 11 of the first housing part 3 a heat-conducting elevation 13 is arranged which extends axially into this recess 13 and ensures an improved cooling of the electronic system 11.

The heat-conducting elevation 13 can be connected directly or indirectly in a heat-conducting manner to the electronic system 11 arranged in the first housing part 3. Expediently in order to avoid direct contact between the heat-conducting elevation 13 and the electronic system 11, an electrical insulating layer 21 and/or a heating-conducting layer 22 can be arranged between the elevation 13 and the electronic system 11. Both the electronic system 11 and also the heat-conducting elevation 13 can be coated with such an electrically insulating layer 21 or a heat-conducting layer 22.

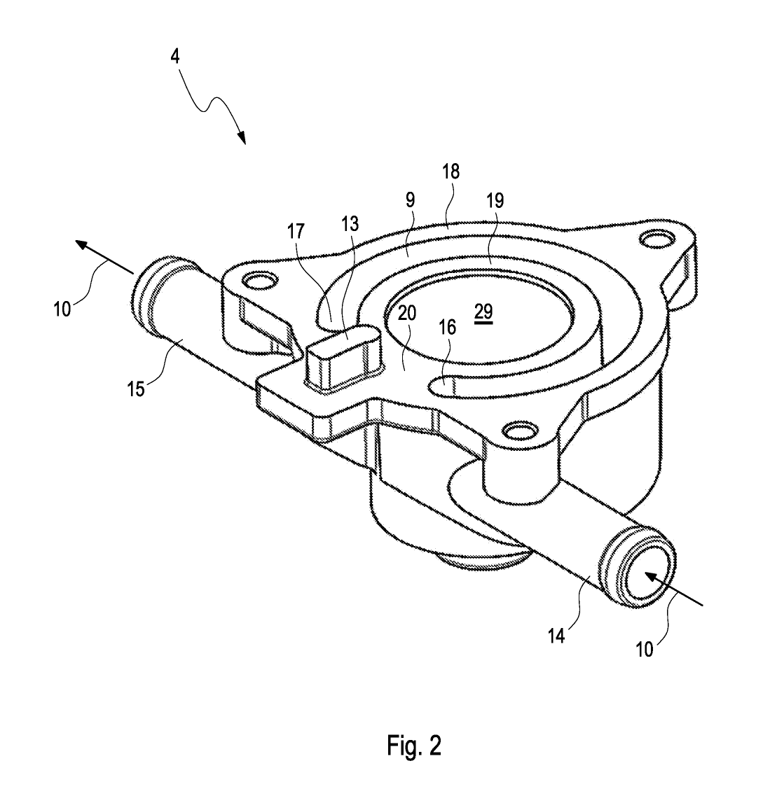

FIG. 2 shows an isometric view of the second housing part 4 of the adjusting device 1, in particular made of a metal material, which is preferably made of an aluminium cast part. The heat-conducting elevation 13 is formed integrally on the second housing part 4 and projects in the direction of the first housing part 3. The elevation 13 is configured in such a manner that it projects at least partially into the recess 12 of the first housing part 3 in the region of the electronic system 11.

The cooling channel 9 extending in the circumferential direction around the electric motor 5 is delimited radially outwards in a fluid-tight manner by an outer jacket wall 18 of the second housing part 4 and is delimited radially inwards in a fluid-tight manner by an inner jacket wall 19 of the second housing part. The inner jacket wall 19 of the second housing part 4 at the same time forms a receiving space 29 in the circumferential direction in which the electric motor 5 is inserted. The coolant 10 initially flows through the coolant inlet connection 14 into a coolant inlet region 16 in the cooling channel 9, from there in the circumferential direction around the electric motor 5 to the coolant inlet region 17 of the cooling channel 9 and finally flows out via the coolant outlet connection 15. A web 20 provided in the cooling channel 9 which is arranged in the region of the heat-conducting elevation 13 and extends radially from the inner jacket wall 19 to the outer jacket wall 18 of the second housing part 4, separates the cooling channel 9 running in the circumferential direction and thereby forms a separation between the coolant inlet region 16 and the coolant outlet region 17.

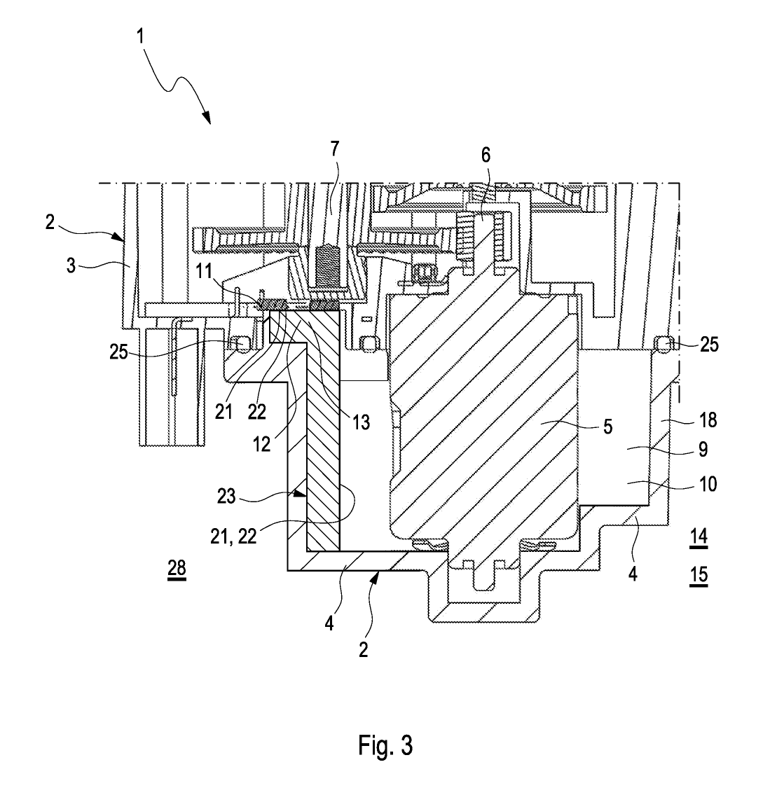

FIG. 3 shows a sectional view in the region of the heat-conducting element 23 in the second housing part 4 of the adjusting device 1. In the embodiment with the associated heat-conducting element 23, the second housing part 4 like the first housing part 3 is made of plastic, in particular as a plastic injection-moulded part. The heat-conducting element 23 which is preferably made of a good heat-conducting metal material, particularly preferably of copper, forms the heat-conducting elevation 13 in the second housing part 4 and extends from the recess 12 in the first housing part 3 as far as the cooling channel 9. Expediently the heat-conducting element 23 is directly exposed to the coolant 10 flowing in the cooling channel 9 and thereby ensures a thermal coupling of the electronic system 11 to the coolant 10. Advantageously the heat-conducting element 23 has an electrically insulating coating 21 at least on the surfaces in direct contact with the coolant 10, in order to avoid short-circuits at the electronic system 11. In the exemplary embodiment shown the cooling channel 9 is formed completely circumferentially and is delimited radially inwards by the electric motor 5 itself which is configured for this purpose as water-tight or encapsulated or is provided with a tight shell. In this embodiment the previously described web 20 is not used. The heat-conducting element 23 can in this case at least partially form the outer boundary of the cooling channel 9 and is therefore in direct or indirect contact, when an electrically insulating coating 21 is applied thereto, with the through-flowing coolant 10. It is clear that at least one further seal not shown here can be provided which prevents any creep of the coolant 10 along the heat-conducting element 23 as far as the first or into the first housing part 3. Such a seal can be supported on the one hand on the heat-conducting element 23 and on the other hand on the first housing part 3 and/or on the second housing part 4.

In a preferred embodiment the heat-conducting element 23 can form the web 20 in the cooling channel 9 and separate the cooling channel 9 between a coolant inlet region 16 and a coolant outlet region 17. The heat-conducting element 23 extends from the inner jacket wall 19 of the second housing part 4 or in the case of an encapsulated electric motor 5, from a sheet metal cup to the outer jacket wall 18 of the second housing part 4, at least in the region of the elevation 13.

Advantageously the heat-conducting element 23 can be at least partially encased or enveloped by the plastic of the second housing part 4 and/or at least partially overmoulded by the plastic of the second housing part 4. Preferred is an incomplete, i.e. only partial encasing or overmoulding so that in the regions of heat transfer, i.e. in the cooling channel 9 and/or in the region of the electronic system 11 to be cooled, no encasing or overmoulding is provided, which considerably improves the heat transfer and therefore the cooling of the electronic system 11.

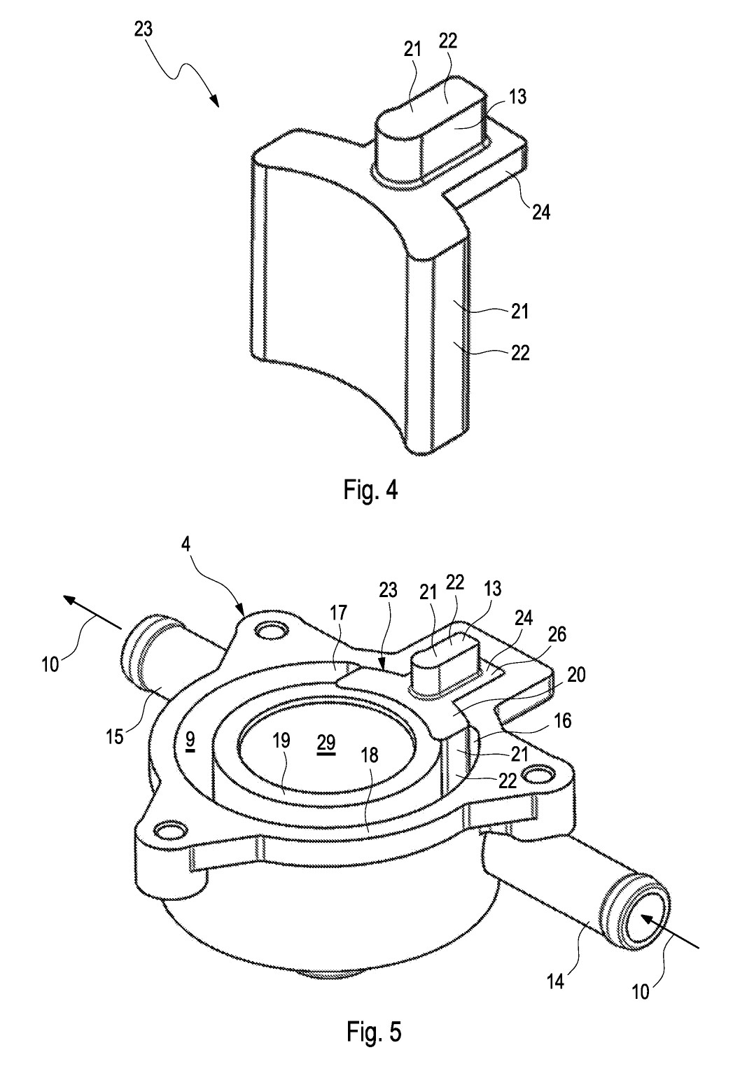

FIG. 4 and FIG. 5 show an isometric view of a heat-conducting element 23 which can be inserted as an independent component into the cooling channel 9 of the second housing part 4. The heat-conducting element 23 here has a heat-conducting contour adapted to the cooling channel 9 which can be inserted in the circumferential direction into the cooling channel 9. Furthermore the heat-conducting element 23 has a radial positioning section 24 which on the side facing away from the elevation 13 projects at least partially in the axial direction into the second housing part 4. The positioning section 24 on the heat-conducting element 23 is used for positioning in the cooling channel 9 and at the same time provides a protection against any undesired slippage of the heat-conducting element 23 in the cooling channel 9. On the second housing part 4 an at least partially radial recess 26 is expediently provided in the region of the positioning section 24, into which the positioning section 24 of the heat-conducting element 23 can be inserted axially.

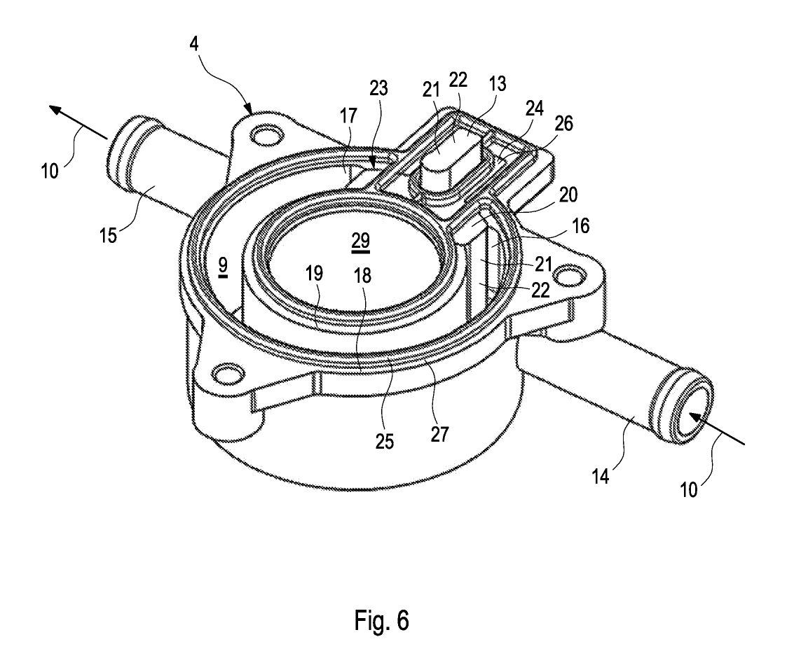

FIG. 6 shows a possible seal profile for sealing the housing 2 of the adjusting device 1 between the first housing part 3 and the second housing part 4. Preferably an axially circumferential groove 27 for receiving a sealing element 25 is arranged in the region of the seal profile both on the first housing part 3 and on the second housing part 4. It would also be feasible that the sealing element 25 consists of a plurality of individual ring seals which on the one hand seal the cooling channel 9 outwards and on the other hand seal inwards to the electric motor 5.

It is preferably provided for simplified assembly of the housing 2 from the first housing part 3 and the second housing part 4 that the respectively facing sides of the housing part with the exception of the recess 12 and the elevation 13 lie in one plane with respect to one another.

In a preferred embodiment an exhaust gas turbocharger 28, not shown, according to the invention for a motor vehicle is fitted with such an adjusting device 1.

1. An actuating device for mechanical actuation of a component of a machine, comprising:
a housing having a first housing part made of plastic and a second housing part;
an electric motor arranged in the second housing part having a drive shaft projecting axially into the first housing part for driving an actuator arranged on an outside of the housing for coupling to the component to be actuated;
a cooling channel formed in the second housing part and through which a coolant is flowable, the cooling channel being fluidically connected to a coolant inlet connection and a coolant outlet connection provided on the outside of the housing;
an electronic system arranged in the first housing part;
an axial recess formed at least in a region of the electronic system on the first housing part;
an axial heat-conducting elevation provided on the second housing part and extending at least in the region of the electronic system axially into the recess.

2. The adjusting device according to claim 1, wherein the elevation is connected to the electronic system directly or indirectly in a heat-conducting manner.

3. The adjusting device according to claim 1, wherein the elevation abuts directly or indirectly against the electronic system via at least one of an electrical insulation and a heat-conducting layer.

4. The adjusting device according to claim 1, wherein the elevation has an electrically conducting coating at least on one surface in contact with the electronic system.

5. The adjusting device according to claim 1, wherein the cooling channel extends in a circumferential direction and is delimited radially between an outer jacket wall of the second housing part outwards and an inner jacket wall of the second housing part inwards.

6. The adjusting device according to claim 5, further comprising a web extending from the outer jacket wall to the inner jacket wall, and in the cooling channel, separating a coolant inlet region connected to the coolant inlet connection from a coolant outlet region connected to the coolant outlet connection.

7. The adjusting device according to claim 6, wherein the elevation is provided in a region of the web.

8. The adjusting device according to claim 1, wherein:
the second housing part is made of metal; and
the elevation is formed integrally on the second housing part and projects therefrom in a direction of the first housing part.

9. The adjusting device according to claim 1, wherein:
the second housing part is made of plastic, and
the second housing part has a metal heat-conducting element on which the elevation is formed and which extends in the second housing part as far as the cooling channel.

10. The adjusting device according to claim 9, wherein the heat-conducting element is exposed to the coolant on or in the cooling channel.

11. The adjusting device according to claim 10, wherein the heat-conducting element has an electrically insulating coating at least on a surface in contact with the coolant.

12. The adjusting device according to claim 7, wherein the heat-conducting element forms the web in the cooling channel.

13. The adjusting device according to claim 9, wherein the heat-conducting element is at least partially encased by the plastic of the second housing part.

14. The adjusting device according to claim 9, wherein the heat-conducting element is at least partially injection-moulded with the plastic of the second housing part.

15. The adjusting device according to claim 9, wherein the heat-conducting element is inserted in the second housing part in a region of the cooling channel.

16. The adjusting device according to claim 9, wherein:
an at least partially radial recess is provided on the second housing part on a side facing the first housing part in a region of the elevation; and
the heat-conducting element has a positioning section in the region of the elevation, the positioning section being arranged radially in the recess.

17. An exhaust gas turbocharger for a motor vehicle, comprising an adjusting device including:
a housing having a first housing part made of plastic and a second housing part;
an electric motor arranged in the second housing part having a drive shaft projecting axially into the first housing part for driving an actuator arranged on an outside of the housing for coupling to the component to be actuated;
a cooling channel formed in the second housing part and through which a coolant is flowable, the cooling channel being fluidically connected to a coolant inlet connection and a coolant outlet connection provided on the outside of the housing;
an electronic system arranged in the first housing part;
an axial recess formed at least in a region of the electronic system on the first housing part;
an axial heat-conducting elevation provided on the second housing part and extending at least in the region of the electronic system axially into the recess.

18. The adjusting device according to claim 2, wherein the elevation abuts directly or indirectly against the electronic system via at least one of an electrical insulation and a heat-conducting layer.

19. The adjusting device according to claim 1, wherein the elevation has an electrically conducting coating at least on one surface in contact with the electronic system.

20. An actuating device for mechanical actuation of a component of a machine, comprising:
a housing having a first housing part made of plastic and a second housing part;
an electric motor arranged in the second housing part having a drive shaft projecting axially into the first housing part for driving an actuator arranged on an outside of the housing for coupling to the component to be actuated;
a cooling channel formed in the second housing part and through which a coolant is flowable, the cooling channel being fluidically connected to a coolant inlet connection and a coolant outlet connection provided on the outside of the housing;
an electronic system arranged in the first housing part;
an axial recess formed at least in a region of the electronic system on the first housing part;
an axial heat-conducting elevation provided on the second housing part and extending at least in the region of the electronic system axially into the recess;
wherein the cooling channel extends in a circumferential direction and is delimited radially between an outer jacket wall of the second housing part outwards and an inner jacket wall of the second housing part inwards
wherein the second housing part is made of plastic and has a metal heat-conducting element on which the elevation is formed and which extends in the second housing part as far as the cooling channel.
